(19) United States
(12) Patent Application Publication
(10) Pub. No.: US 2024/0354650 A1
(43) Pub. Date: Oct. 24, 2024

(54) MACHINE LEARNING FOR REAL-TIME CONTEXTUAL ANALYSIS IN CONSUMER SERVICE

(71) Applicants: Amanda Jo TRIOLO, Latham, NY (US); Brianna Aurelia SKIFFINGTON, Latham, NY (US); Luis Jorge GUARENA, Miami, FL (US)

(72) Inventors: Amanda Jo TRIOLO, Latham, NY (US); Brianna Aurelia SKIFFINGTON, Latham, NY (US); Luis Jorge GUARENA, Miami, FL (US)

(21) Appl. No.: 18/641,368

(22) Filed: Apr. 20, 2024

Related U.S. Application Data
(60) Provisional application No. 63/461,091, filed on Apr. 21, 2023.

(51) Int. Cl. G06N 20/00

(52) U.S. Cl. CPC G06N 20/00

(57) ABSTRACT

Computer-implemented methods, computer program products, and computer systems, include a processor(s) that trains machine learning algorithms to recommend an action based on receiving an audio communication via a consumer interface. The processor(s) obtains the audio communication via the consumer interface and converts the audio communication to textual content in real-time or in near real-time. The processor(s) classifies an originator of the audio communication as a given personality type. The processor(s) expands the customer information based on accessing a customer relationship management system. The processor(s) selects at least one machine learning algorithm from the one or more machine learning algorithms and applying the at least one machine learning algorithm to the expanded customer information, obtains the action, and implements the action.

### CROSS-REFERENCE TO RELATED APPLICATION

This application claims the benefit of and priority to U.S. Provisional Patent Application No. 63/461,091 filed Apr. 21, 2023, the content of which is incorporated by reference herein in its entirety and for all purposes.

### BACKGROUND OF INVENTION

In various industries, including but not limited to the home services sector, customer interaction management plays a crucial role in delivering quality services and ensuring customer satisfaction. Traditionally, this process involves multiple roles, such as call-by-call managers and finance managers, who assist service providers or technicians in offering accurate pricing, service options, and financing solutions to customers.

Service providers often rely on call-by-call managers to verify pricing and obtain approval for various service options. This process can be time-consuming and prone to human errors, as providers must communicate with multiple managers and gather information from different sources. In addition to verifying pricing and service options, providers may also need to consult with finance managers to determine suitable financing options for customers based on factors such as credit scores, financing preferences, and recent financial activities.

The involvement of multiple managers and the need for manual communication and coordination can result in inefficiencies and inconsistencies in service offerings and customer experiences. Moreover, the traditional process may not fully utilize available customer data, such as property information and audience demographics, which could help service providers better understand customer buying propensities and tailor their recommendations accordingly.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY OF INVENTION

Shortcomings of the prior art are overcome and additional advantages are provided through the provision of a method for facilitating a next action in a system. The method includes, for instance: training, by one or more processors, one or more machine learning algorithms to recommend an action based on receiving an audio communication via a consumer interface; obtaining, by the one or more processors, the audio communication via the consumer interface, wherein the one or more processors access the customer relationship management system via a first application programming interface; progressively converting, by the one or more processors, the audio communication to textual content in real-time or in near real-time; classifying, by the one or more processors, an originator of the audio communication as a given personality type from a pre-determined group of personality types based on analyzing the textual content, wherein the given personality type and the textual content comprise customer information; expanding, by the one or more processors, the customer information based on accessing a customer relationship management system via a second application programming interface and at least one additional data source to obtain data relevant to the originator of the audio communication; selecting, by the one or more processors, at least one machine learning algorithm from the one or more machine learning algorithms and applying the at least one machine learning algorithm to the expanded customer information; based on the applying, obtaining, by the one or more processors, the action; and implementing, by the one or more processors, the action.

Shortcomings of the prior art are also overcome and additional advantages are provided through the provision of a system for facilitating a next action in a system. The system includes: a memory; and one or more processors in communication with the memory, wherein the computer system is configured to perform a method, said method comprising: training, by the one or more processors, one or more machine learning algorithms to recommend an action based on receiving an audio communication via a consumer interface; obtaining, by the one or more processors, the audio communication via the consumer interface, wherein the one or more processors access the customer relationship management system via a first application programming interface; progressively converting, by the one or more processors, the audio communication to textual content in real-time or in near real-time; classifying, by the one or more processors, an originator of the audio communication as a given personality type from a pre-determined group of personality types based on analyzing the textual content, wherein the given personality type and the textual content comprise customer information; expanding, by the one or more processors, the customer information based on accessing a customer relationship management system via a second application programming interface and at least one additional data source to obtain data relevant to the originator of the audio communication; selecting, by the one or more processors, at least one machine learning algorithm from the one or more machine learning algorithms and applying the at least one machine learning algorithm to the expanded customer information; based on the applying, obtaining, by the one or more processors, the action; and implementing, by the one or more processors, the action.

Shortcomings of the prior art are overcome and additional advantages are provided through the provision of a computer program product for facilitating a next action in a system. The computer program product comprises a storage medium readable by a processing circuit and storing instructions for execution by the processing circuit for performing a method. The method includes, for instance: training, by the one or more processors, one or more machine learning algorithms to recommend an action based on receiving an audio communication via a consumer interface; obtaining, by the one or more processors, the audio communication via the consumer interface, wherein the one or more processors access the customer relationship management system via a first application programming interface; progressively converting, by the one or more processors, the audio communication to textual content in real-time or in near real-time; classifying, by the one or more processors, an originator of the audio communication as a given personality type from a pre-determined group of personality types based on analyzing the textual content, wherein the given personality type and the textual content comprise customer information; expanding, by the one or more processors, the customer information based on accessing a customer relationship management system via a second application programming interface and at least one additional data source to obtain data relevant to the originator of the audio communication; selecting, by the one or more processors, at least one machine learning algorithm from the one or more machine learning algorithms and applying the at least one machine learning algorithm to the expanded customer information; based on the applying, obtaining, by the one or more processors, the action; and implementing, by the one or more processors, the action.

Methods and systems relating to one or more aspects are also described and claimed herein. Further, services relating to one or more aspects are also described and may be claimed herein. Additional features are realized through the techniques described herein. Other embodiments and aspects are described in detail herein and are considered a part of the claimed aspects.

It should be appreciated that all combinations of the foregoing aspects and additional concepts discussed in greater detail below (provided such concepts are not mutually inconsistent) are contemplated as being part of the inventive subject matter and to achieve the advantages disclosed herein.

### BRIEF DESCRIPTION OF DRAWINGS

One or more aspects of the present invention are particularly pointed out and distinctly claimed as examples in the claims at the conclusion of the specification. The foregoing and objects, features, and advantages of one or more aspects of the invention are apparent from the following detailed description taken in conjunction with the accompanying drawings.

FIG. 1 is a workflow that illustrates various aspects of some embodiments of the present invention.

FIG. 2 illustrates a machine learning model that is an aspect of certain of the examples herein.

FIG. 3 is a workflow that illustrates various aspects of some embodiments of the present invention.

FIG. 4 is a workflow that illustrates various aspects of some embodiments of the present invention.

FIG. 5 is a workflow that illustrates various aspects of some embodiments of the present invention.

FIG. 6 is a workflow that illustrates various aspects of some embodiments of the present invention.

FIG. 7 is a workflow that illustrates various aspects of some embodiments of the present invention.

FIG. 8 is a workflow that illustrates various aspects of some embodiments of the present invention.

FIG. 9 is an example of a graphical user interface that is an aspect of some examples herein.

FIG. 10 illustrates a block diagram of a resource in computer system, which is part of the technical architecture of certain embodiments of the technique.

FIG. 11 illustrates a computer program product which includes one or more non-transitory computer readable storage media to store computer readable program code means or logic thereon to provide and facilitate one or more aspects of the technique.

### DETAILED DESCRIPTION OF THE INVENTION

Aspects of the present invention and certain features, advantages, and details thereof, are explained more fully below with reference to the non-limiting examples illustrated in the accompanying drawings. Descriptions of well-known materials, fabrication tools, processing techniques, etc., are omitted so as not to unnecessarily obscure the invention in detail. It should be understood, however, that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. The terms software and program code are used interchangeably throughout this application and can refer to logic executed by both hardware and software. Components of the system that can be utilized to execute aspects of embodiments of the present invention may include specialized hardware, including but not limited to, an FPGA and a GPU (graphics professor unit). Additionally, items denoted as processors may include hardware and/or software processors or other processing means, including but not limited to a software defined radio and/or custom hardware.

Embodiments of the present invention include computer implemented method, computer program products, and computer systems where program code executed by one or more processors trains and applies one or more machine learning algorithms to recommend or implement a next action. In some examples, the program code implements a speech to text conversion system and performs a contextual analysis of content received as audio and converted to text to determine and implement and/or recommend a next action. The program code recommends and/or implements a next action based on:1) automatically enhancing or supplementing the contextual data to increase the data for analysis; and 2) performing a contextual analysis of the enhanced or supplemented data; this analysis can include applying one or more (e.g., self-learning) machine learning algorithms. The systems, computer-implemented methods, and computer program products described herein provide a system and method for real-time customer interaction recording, AI-enabled analysis, coaching facilitation, and dynamic CRM injection with an integrated marketplace of publishers.

As understood by one of skill in the art, program code, as referred to throughout this application, includes both software and hardware. For example, program code in certain embodiments of the present invention includes fixed function hardware, while other embodiments utilized a software-based implementation of the functionality described. Certain embodiments combine both types of program code. One example of program code includes a program/utility, having a set (at least one) of program modules, stored in a memory.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Current methods of managing customer interactions have several limitations, including a lack of automation and integration, potential human biases, and a reliance on manual processes. These limitations can result in suboptimal service recommendations, slow response times, and a reduced ability to tailor solutions to individual customer needs. There is a need for a more efficient and integrated system that can automate and streamline the customer interaction management process across various industries, both for in-home and phone-based interactions. Addressing this need, the examples herein include computer system, computer program products, and computer-implemented methods that reduce reliance on multiple managers, improve the accuracy and consistency of service recommendations and pricing, facilitate the provision of personalized financing options for customers, and leverage enriched customer data to optimize recommendations based on patterns over time. The practical application(s) of the examples herein are accomplished based on these examples being inextricably tied to computing.

The examples herein are inextricably tied to computing and are directed to a practical application. As aforementioned, the examples herein are tied to a practical application because there exists a need to improve accuracy, efficiency, and speed of customer interactions across industries. As will be described in greater detail herein, in the methods, systems, and computer program products are inextricably tied to computing as they utilize machine learning and hence, generative artificial intelligence, in order improve accuracy, efficiency, and speed. In some examples, program code executing on one or more processors utilizes data, including demographic information, to train a machine learning algorithm to: 1) enhance customer data to provide contextual information; and 2) utilize the contextual information to recommend and/or automatically trigger an action within, for example, a customer service system. As will be described herein, in some examples, program code executing on one or more processors converts audio to textual content in real-time and automatically analyzes and augments the textual data. Based on the textual data, the program code can utilize one or more trained machine learning algorithms to obtain property data, audience data, and customer buying propensities, relevant to the analyzed textual data. The program code can determine an action based on this analysis. In some examples, the program code generates accurate and personalized service recommendations, pricing, and/or financing options for a given customer based on determinations made by the program code about the customer, including but not limited to, the unique needs and preferences of the customer. The examples herein can include an application programming interface (API) that automatically integrates with existing customer relationship management (CRM) software. The program code can comprise one or more large language model (LLM) and can also integrate with one or more existing LLM to analyze the textual context and derive and/or analyze additional context.

The examples herein provide significantly more than existing inquiry and customer management solutions. Many customer management techniques are subjective and require manual decision-making without contextual information which could guide this decision-making. The examples herein efficiently replace multiple managerial roles, such as call-by-call and finance managers. As opposed to existing approaches, the examples herein provide a versatile system and method for automating and streamlining customer interaction management across various industries, including but not limited to the home services sector. Additionally, the examples herein can be utilized in different settings, including but not limited to both in-home and phone-based customer interactions, and hence, the examples herein can be utilized in multiple scenarios. Because the examples herein are self-learning, they are continuously self-optimizing and can find and apply patterns over time, and hence can provide significant improvements in efficiency, consistency, and customer satisfaction, transforming the traditional process of managing customer interactions across industries. Benefits of utilizing the examples herein can include reduced reliance on subjective managerial oversight, increased accuracy in customer service through real-time data integration, personalized coaching at scale, and the ability to continuously update and improve coaching strategies based on latest best practices.

The examples herein are directed to a practical application. Effective management of customer interactions is vital across various industries to ensure high-quality service delivery and customer satisfaction. Traditionally, this process has been managed by supervisors or managers who provide guidance based on their subjective understanding and personal experiences. This conventional approach, relying heavily on the accuracy of employees' recollections and managers' interpretations, is inherently flawed due to biases and the incomplete nature of human memory. The examples herein provide significantly more than these existing approaches and are directed to a practical application at least because some examples herein introduce a transformative approach that automates (including with the use of AI), the recording and transcription of customer interactions and enhances these capabilities with real-time CRM data integration. In these examples, program code executing on one or more processors, not only provides an objective basis for decision-making but also supports it with a comprehensive contextual backdrop, including but not limited to, historical customer data, transaction records, and/or other relevant information. By replacing subjective managerial guidance with data-driven insights, the examples herein significantly improve the accuracy and the effectiveness of customer service.

As will be discussed in greater detail herein, one aspect of certain of the examples herein that provides enables the examples to effectively address the know need in the industry is a training marketplace, which connects businesses with a broad network of industry experts. In these examples, this marketplace serves as a dynamic hub where business owners can access and deploy expert-designed coaching modules directly into their employees' workflows, providing real-time guidance and feedback. This facility enables personalized coaching at scale, tailored to the nuances of each interaction—a significant improvement over the sporadic and often generic coaching of traditional models.

Some examples enable the inclusion of third-party technologies for increased utility. Third party data and systems that can be utilized by the program code in examples herein include, but are not limited to, property information (e.g., from commercial providers including but not limited to Zillow and Trulia), demographic data from census records, and/or data from other external databases. This capability will further enrich the context of customer interactions, offering precise and personalized service based on additional data and analysis of these data.

The examples herein comprise continuous learning environments as the AI models utilized are continuously improving themselves. Additionally, by facilitating integrations and fostering this continuous learning environment both through the use of machine learning and through a direct connection with a community of expert coaches, the latter of whom continuously update and refine their coaching modules based on evolving best practices, the program code can be utilized in a wider range of contexts. The examples herein remains at the forefront of industry practices, continuously evolving to meet the changing needs of businesses and markets, thereby democratizing access to expert knowledge and enabling businesses of all sizes to benefit from top-tier coaching and training methodologies.

Examples herein include a comprehensive system and method designed to transform customer interaction management across various industries through significant technological advancements. The invention automates the capture and transcription of real-time audio during customer interactions, ensuring accurate and immediate data entry. This transcription, combined with dynamic CRM data integration, provides a robust contextual backdrop for each interaction, enabling precise and personalized customer service. A unique aspect of the system is its integrated marketplace, which connects businesses with a diverse array of AI-driven coaching bots developed by industry experts. These bots analyze the real-time data to provide immediate, tailored feedback to employees, substantially reducing the time traditionally required for training and performance assessments. Moreover, the system is designed to outperform existing customer interaction management solutions by providing a unified platform that combines real-time data transcription, expert-driven AI coaching, and dynamic CRM integration. This integration not only saves considerable time by eliminating manual data retrieval and entry but also improves the accuracy and effectiveness of customer interactions. The ability to quickly adapt to and integrate future data sources such as third-party demographic and property information further enhances the system's utility, making it superior to traditional methods that lack flexibility and real-time capabilities. These improvements ensure that the invention offers not only faster but also more reliable and adaptable solutions for customer interaction management, setting a new standard in the field.

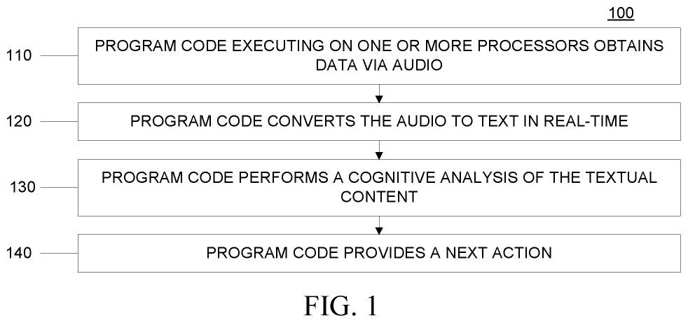

FIG. 1 is a general overview of a workflow 100 integrated into various examples herein. As illustrated in FIG. 1, program code executing on one or more processors obtains data via audio (100). The program code converts the audio to text in real-time (120). The program code performs a cognitive analysis of the textual content (130). As will be explained herein, the cognitive analysis can include applying one or more machine learning algorithms and/or contextual analysis models. Based on the cognitive analysis, the program code provides a next action (140). In some examples, the next action is a recommendation, in others, the action includes the program code automatically initiating an action. In some examples, the action is providing a next step to an individual interacting with the source of the audio (e.g., an individual interacting with a consumer). The actions and recommendations provided by the program code can be understood, in some examples, as dynamic coaching expertise. The processes providing these recommendations can include AI-driven coaching bots developed by industry experts. Each bot can be deployed directly into the company's workflow to provide real-time guidance and feedback to employees during customer interactions. These bots are designed to analyze interaction transcripts and CRM data to offer actionable advice and coaching, helping employees enhance their communication and service delivery skills.

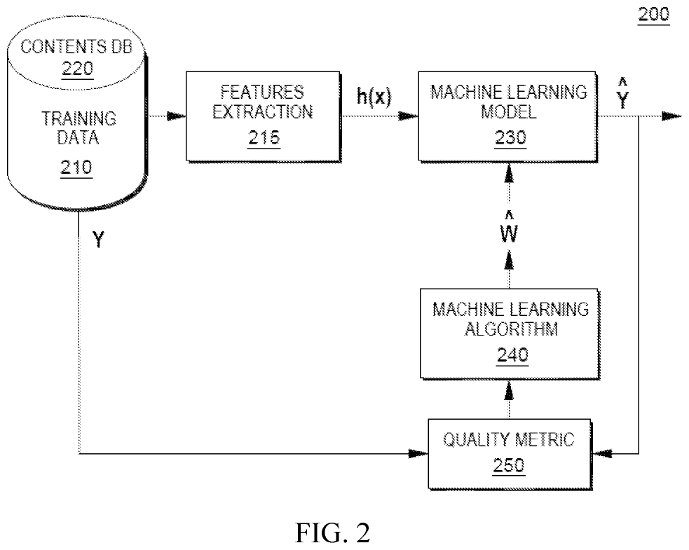

As aforementioned, in some examples, herein, program code executing on one or more processor trains one or more machine learning algorithms to analyze content received via audio (and converted by the program code to text in real-time), to supplement the data provided with additional data, to analyze the full data set, and to recommend and/or initiate an action based on the analysis. Hence, various embodiments of the present invention include a machine learning training system. FIG. 2 is an example of a machine learning training system 200 that can be utilized to perform cognitive analyses of text received from a user (as aforementioned, this is text that was audio data received by the program code and converted, in real-time, to textual content) to generate a next action (a recommendation and/or initiate an action). In some examples herein, one or more algorithms are trained by program code before implementation into an embodiment. In some examples, the program code is continuously trained and improved based on utilization in the context of the examples herein. In some examples, rather than generate and/or train a new machine learning algorithm, an administrative user and/or automated process can select an existing machine learning or other AI model (e.g., AI bot) and this existing model is integrated into an embodiment of the present invention.

In some examples where the program code trains a machine learning model, to train the machine learning training system 200, the program code can be provided access to demographic information, including but not limited to, an existing database of customers relevant to the CRM that is being integrated with the examples herein. The program code can train the machine learning algorithm based on this existing data to recognize patterns in incoming data (e.g., from new customer interactions).

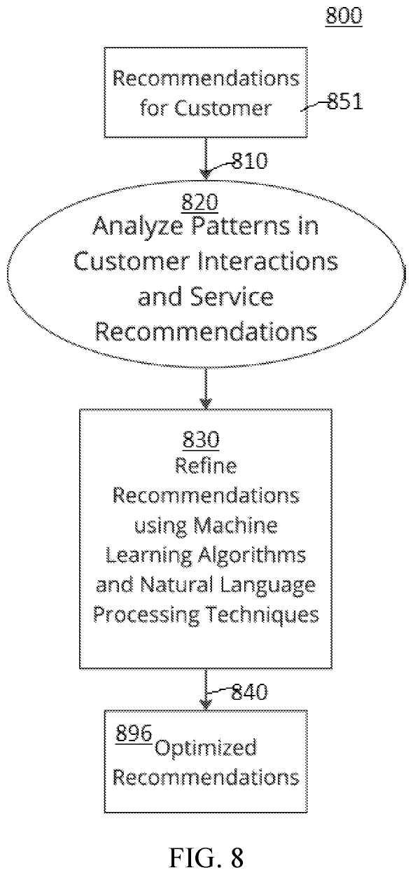

Machine learning (ML) solves problems that cannot be solved by numerical means alone. In this ML-based example, program code extracts various features/attributes from training data 240, which can be resident in one or more databases 220 comprising customer data, including demographic data, financial data, and/or purchase histories. In some embodiments of the present invention, the training data 240 can comprise historical activity data of the user. Training data 240 in these examples can also include part customer interactions, service recommendations provided to those customers, and results of these customer interactions. As discussed herein, including in FIG. 8, the program code can identify and analyze patterns in customer interactions and service recommendations to train a machine learning algorithms to provide improved recommendations. The program code can refine the recommendations utilizing the machine learning algorithm as well as NLP techniques to provide optimized recommendations. The features are utilized to develop a predictor function, h(x), also referred to as a hypothesis, which the program code utilizes as a machine learning model 230. In identifying various features/attributes (e.g., patterns) in the training data 240 (e.g., patterns in customer interactions and service recommendations), the program code can utilize various techniques including, but not limited to, mutual information, which is an example of a method that can be utilized to identify features in an embodiment of the present invention. Further embodiments of the present invention utilize varying techniques to select features (elements, patterns, attributes, etc.), including but not limited to, diffusion mapping, principal component analysis, recursive feature elimination (a brute force approach to selecting features), and/or a Random Forest, to select the features. The program code can utilize a machine learning algorithm 240 to train the machine learning model 230 (e.g., the algorithms utilized by the program code), including providing weights for the conclusions, so that the program code can prioritize recommendations (next actions either recommended and/or automatically initiated by the program code) in accordance with the predictor functions that comprise the machine learning model 230. The conclusions can be evaluated by a quality metric 250. By selecting a diverse set of training data 210, the program code trains the machine learning model 230 to identify and weight various attributes (e.g., features, patterns) that correlate to actions (e.g., purchases, service requests). Based on modeling the patterns in the customer data, the program code can predict/determine a “next action” in various scenarios that the program code determines are present based on performing a cognitive contextual analysis of the text. When the program code provides a recommendation, it can be understood as an optimized recommendation.

Various embodiments of the present invention convert audio to text in advance of performing an analysis on the text. However, in some examples, the program code can perform additional analyses on the audio data. In these examples, to analyze the audio data, the program code can utilize APIs that process the audio. The various APIs can include, but are not limited to, a tone analyzer API, a personality insight API, a text to speech API, and a translation API. In some embodiments of the present invention, the program code compares context derived from natural language processing (NLP) of a conversation contemporaneous with receiving a customer inquiry in a CRM system.

In some embodiments of the present invention, the cognitive natural language processing (NLP) capabilities of the program code, which can include an analysis of the text with or without audio features, are implemented as a machine learning system that includes a neural network (NN). In certain embodiments of the present invention the program code utilizes supervised, semi-supervised, or unsupervised deep learning through a single- or multi-layer NN to correlate various attributes from unstructured and structured data related to a user (e.g., data obtained via audio and converted to text and supplemental data enhancing the text based on further analysis). The program code utilizes resources of the NN to identify and weight connections from the attribute sets in the audio (or converted audio) to determine the context of the conversation(s) and whether the conversation(s) are relevant to a given preference or demographic information. For example, the NN can identify certain keywords that indicate a relevance to a personality type or demographic type or other group preference.

As understood by one of skill in the art, neural networks are a biologically-inspired programming paradigm which enable a computer to learn from observational data. This learning is referred to as deep learning, which is a set of techniques for learning in neural networks. Neural networks, including modular neural networks, are capable of pattern recognition with speed, accuracy, and efficiency, in situation where data sets are multiple and expansive, including across a distributed network of the technical environment. Modern neural networks are non-linear statistical data modeling tools. They are usually used to model complex relationships between inputs and outputs or to identify patterns in data (i.e., neural networks are non-linear statistical data modeling or decision making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in image recognition, speech recognition, and natural language processing (NLP). Thus, by utilizing an NN the program code can identify attributes and correlate these attributes with a next action, which can be a recommendation.

The one or more machine learning algorithms that the program code applies to data related to a customer can include AI-driven coaching bots configured for detailed data analysis including personality typing and sentiment analysis. Although certain types of AI-analyses are provided as examples herein, when an administrator configures the examples herein for use within the context of a particular industry or system, the administrator can configure specific algorithm or bots to analyze the data and provide recommendations (e.g., guidance). An administrative user can select and deploying one or more an AI-driven coaching bot to monitor real-time customer interactions.

In some examples, rather than utilizing the machine leaning model training architecture of FIG. 2, the examples herein integrate trained models (e.g., OpenAI models), into the embodiments described herein. Thus, rather than train a machine learning model from scratch, program code in the examples herein fine tune an existing trained mode using an organic dataset. In some examples, when embodiments of the invention are deployed for use by customer, the administrative users among the customers can select from existing and/or proprietary AI models (where the existing models were optionally trained with an organic dataset) and implement the selected models.

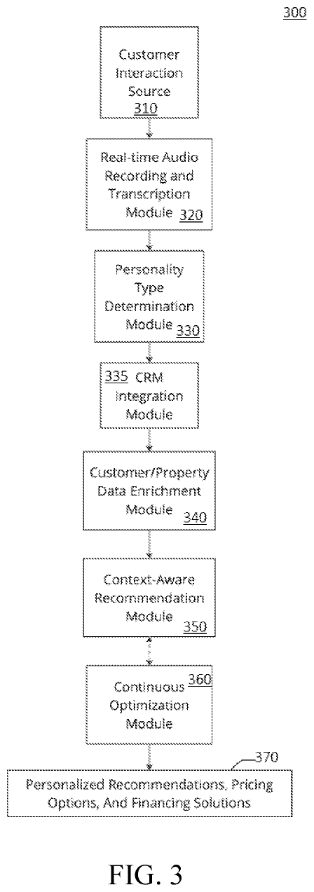

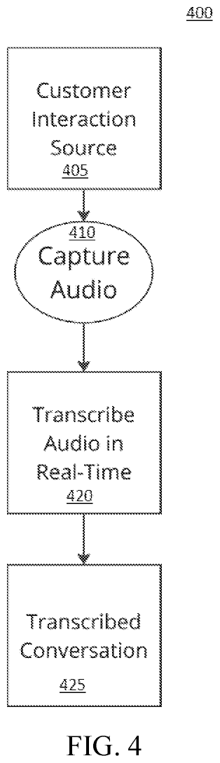

As understood by one of skill in the art, aspects of the examples described herein can be utilized across many industries. However, in many of the examples herein, for illustrative purposes only, the aspects are described in the context of a system utilized for management of customer inquiries. In these examples, the input includes a customer contact, provided via audio, and the output is a recommendation and/or automatically initiated action, which the program code determines is a best response to the inquiry, based on analysis performed by the program code. In many of the flowcharts and workflows illustration herein, various actions performed by the program code are characterized as modules. However, separating these functions into modules is an example of a possible configuration for the examples herein and is provided for illustrative purposes and not to suggest any limitations. FIG. 3 provides a workflow 300 that generalizes various aspects of some examples herein. This workflow 300 illustrates the interactions between various functionalities, here represented as modules. FIGS. 4-8 are workflows 400-800 that provide additional detail related to various aspects of the workflow 300 of FIG. 3.

In some examples herein, as illustrated in FIG. 3, program code executing on one or more processors obtains data from a user. In this example, this user data is referred to as a customer interaction source 310. The interaction obtained by the program code is provided, in this non-limiting examples, via audio. Program code obtains the audio (including progressively) and transcribes and saves it in real-time, in this example, the program code that performs this activity is referred to as a real-time recording and transcription module 320. Program code comprising the real-time recording and transcription module 320 can capture audio from customer interactions, whether in-person or over digital communication channels. Program code records (and can store) the audio in real-time and transcribe it into text. This transcription process ensures that all verbal communication is accurately converted into a readable and analyzable format, providing a reliable foundation for further analysis and decision-making. In some example, the program code utilizes an advanced speech recognition technology that is capable of handling various accents and dialects, thereby maintaining high accuracy across diverse customer bases.

Returning to FIG. 3, in some examples, the program code analyzes the now textual data (the transcribed audio) and determines a personality type for the user. In this example, the program code that performs this determination is referred to as a personality type determination module 330. The program code can obtain additional data to provide additional context to enable analysis of the existing data. Thus, in some examples, the program code accessing one or more databases to obtain customer data, including demographic data (e.g., property data) to supplement and/or complement the personality type data and the original data. For example, the program code can integrate with a CRM system 335 to gain access to additional data. The program code performing this function is referred to as a customer/property data enrichment module 340. The program code applies one or more trained machined learning models in order to initiate and/or recommend one or more additional actions based on the context (e.g., original data, personality type data, and/or machine learning model output), as illustrated in FIG. 3 as a context-aware recommendation module 350. As illustrated in this workflow 300, the program code consistently trains and re-trains the machine learning models to consistently optimize the recommendations that it provides, in this example, via a continuous optimization module 360. The actions recommended by the program code based on the context-aware recommendation module 350 can be selected from options provided to the program code. The program code, based on the analyses can match possible options with a given user (e.g., consumer). The options can be obtained by the program code as pricing options and financing solutions. Thus, the program code can provide to a user, based on traversing the workflow 300, as an action, personalized recommendations, pricing options, and/or financing solutions 370. Providing these types of recommendations is merely an example of actions that can be generated by the program code based on the various analyses performed by the program code and are provided for illustrative purposes. Although, for ease of understanding, FIG. 3 illustrates the program code performing various analyses on the transcribed conversation in a certain order, the order of the analyses (e.g., personality type and enrichment of data via third-part data or an integration with a CRM system) can differ based on an implemented configuration. For example, the analyses may occur in an opposite order as well as simultaneously, in parallel, and/or concurrently in different orders. FIG. 3 is meant to provide a possible example and is not limiting. In some examples herein, when the program code determines that a customer interaction has begun, program code comprising a real-time audio recording and transcription module captures and transcribes the conversation. In these examples, simultaneously, program code comprising a CRM data integration module retrieves relevant data from the CRM system to provide context to the ongoing interaction. This data, along with the transcription, is analyzed by one or more machine learning algorithms, which are also referred to herein as selected coaching bots from relevant marketplaces, which then provides real-time feedback and guidance (e.g., to assist an employee handling the interaction). A benefit of the examples herein is that they enable informed by comprehensive data and expert advice, leading to improved customer satisfaction and operational efficiency.

In the examples, herein, the program code executing on one or more processors operated continuously to provide actions and/or recommendations to a customer. Rather than viewing FIG. 3 as a singular workflow 300, it can be understood as cyclical where the program code continuously provides recommendations or next actions. For example, when integrated for use with a CRM, a potential customer can make an inquiry and provide audio data while making this inquiry. Program code transcribes the audio, in real-time, the program code enriches this customer data by determining a personality type for the customer and/or accessing third-party data. Based on analyzing the customer data utilizing one or more trained machine learning algorithm, the program code provides, for example, a recommendation (which can be understood as an optimized recommendation). However, an inquiry can be ongoing and thus, the recommendations from the program code can be understood as a script provided to an individual interacting with the customer that provides ongoing recommendations based on the responses of the customer. Thus, the program code in the examples herein can guide a representative through a customer service interaction, step by step, based on the machine learning algorithms continuously evaluating the customer data. In some examples, the recommendation provided by the program code, rather than a single action or recommendation for a single action, is a script, that a customer service representation can utilize to guide a customer interaction. The program code can continuously analyze and refine recommendations provided in real-time, contemporaneously as the system fields a customer inquiry.

Program code in the examples herein can provide the optimized recommendations to various applications which can utilize these recommendations for various tasks, including but not limited to tagging phone calls in a CRM system, informing sales strategies, and/or reselling data to other businesses. By utilizing outputs of the examples herein for broad applications, one can realize an enhanced values for systems, computer-program products, and computer-implemented systems described herein.

The various AI processes that the program code performs on the data and the enriches data include the application of AI bots that are developed by industry experts and can be selected and implemented via an interface. For example, an AI bot may apply a personality analysis while another utilizes patterns in historical purchase data.

FIG. 4 is an example of a workflow 400 of the conversion or transcription functionality described herein, including as illustrated in FIG. 3 (e.g., real-time recording and transcription module 320). FIG. 4 illustrates the real-time audio recording and transcription module, detailing the process of capturing audio from customer interactions, transcribing the audio in real-time, and passing the transcriptions to the subsequent modules. As illustrated in FIG. 4, program code executing on one or more processors, obtains the audio (including progressively) from a customer interaction source 405, captures the audio 420, and transcribes and saves it in real-time. As illustrated in FIG. 4, the program code captures the audio (410), transcribed the audio in real-time (420), and produces a transcribed conversation (e.g., textual data) 425.

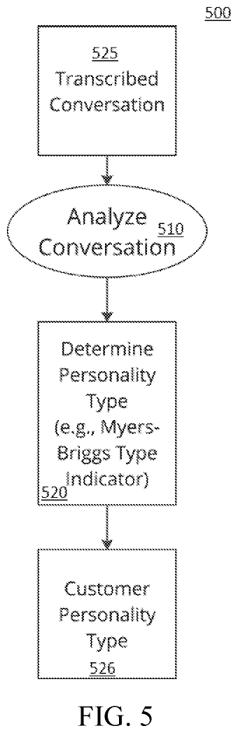

FIG. 5 illustrates a workflow 500 of the personality type evaluation functionality of certain examples, as illustrated as a personality type determination module 330 in FIG. 3. FIG. 5 illustrates the workings of the personality type determination module, showcasing how the module processes the transcribed conversation and utilizes a personality assessment framework (e.g., Myers-Briggs Type Indicator, DISC profile) to determine the customer's (e.g., user's) personality type. Referring to FIG. 5, the program code obtains the transcribed conversation 525 (e.g., FIG. 4, transcribed conversation 425) and analyzes the textual data to make a personality type determination (510). In this example, the program code utilizes a Myers-Briggs indicator 535 to determine the customer personality type 526 (520). In other examples, the program utilizes a DISC personality assessment.

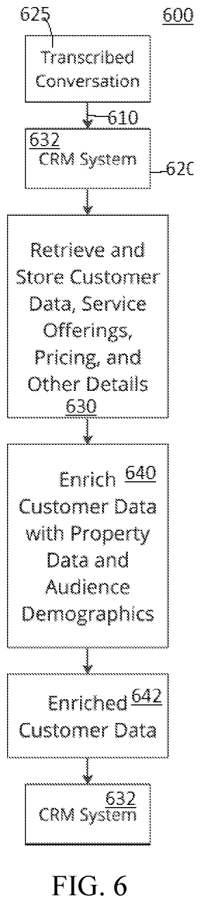

FIG. 6 illustrates a workflow 600 related to the customer/property data enrichment module 340 of FIG. 3. FIG. 6 illustrates how in some examples, the program code is communicatively coupled to resources of a CRM systems and the program code utilizes data stored in the CRM system to enrich, supplement, and/or complement the transcribed data and the personality data. The workflow 600 of FIG. 6 illustrates that program code obtaining and storing customer data, service offerings, pricing information, and/or other relevant details, and the program code enriching the customer data with additional information, including but not limited to, property data and audience demographics. In this example, program code executing on one or more processors obtains the transcribed conversation 625 (e.g., FIG. 4, transcribed conversation (e.g., textual data) 425) (610). The program code accesses a third-party system, which in this example, is a CRM 632 (620). Based on accessing the CRM, the program code parses the transcribed conversation for identifying information and utilizes it to obtain, from or more data sources, additional information relevant to the user (e.g., customer), including but not limited to customer data, service offerings, pricing, and/or other details (630). Based on obtaining data from the data sources, the program code enriches the customer data with property data and audience demographics (640). The program code then can provide the enhanced customer data 642 to the CRM 632 as well as to additional applications, including using it within the present examples.

In examples where the program code is integrated with a CRM system, the program code can pulls in historical interaction data, customer transaction records, and personal information that can provide a richer context to each customer interaction. For instance, previous purchase history and service preferences can be used to tailor current interactions and improve service delivery. The integration can comprise a secure API connection to ensure data integrity and privacy while enabling real-time data retrieval and updates.

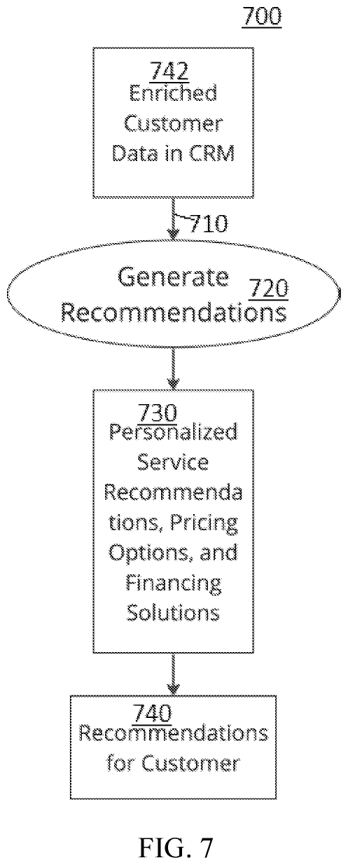

FIG. 7 illustrates a workflow 700 where the program code generates a recommendation, including by applying one or more machine learning algorithms to the enhanced/enriched customer data 742, 642. FIG. 7 illustrates the context-aware recommendation module 350 from FIG. 3 and how the program code generates personalized service recommendations, pricing options, and/or financing solutions based on the enriched customer data. As illustrated in FIG. 7, the program code obtains the enhanced/enriched customer data 742 (e.g., enhanced/enriched customer data 642, FIG. 6) (710) and applies on or more (trained) machine learning algorithms to generate one or more recommendations (or initiate one or more actions) (720). In this example, the program code generates the one or more recommendations as personalized service recommendations, pricing options, and/or financing solutions (730). The program code provides the one or more recommendations to the user (customer) (740). As discussed above, the manner in which a recommendation is provided to a customer can vary. For example, when the examples herein are implemented in a system where service providers interact with consumers, the recommendations can be provided, in real-time, to a service provider who is interacting with the customer (in a GUI utilized by the service provider). The recommendation can be part of a script that the service provider uses when interacting with the customer. In some examples, the program code can generate an entire script at one time rather than continuous produce recommendations as a customer and a service provider work through a conversation.

FIG. 8 is a workflow 800 similar to that of FIG. 2 where program code of the continuous optimization module 360 (FIG. 3) utilizes recommendations (e.g., as training data) to generate and provide optimized recommendations. FIG. 8 illustrates various aspects of program code comprising the continuous optimization module 360 (FIG. 3) and how this program code applies machine learning algorithms and NPL techniques to refine recommendations by analyzing patterns in customer interactions and service recommendations, over time (e.g., training data). As illustrated in FIG. 8, program code comprising the continuous optimization module 360 (FIG. 3) obtains recommendations for customers 851 (810). These recommendations can be those generated by the program code in the past, historical data, and/or manually entered recommendations. The program code identifies and analyzes patterns in the customer data (including in customer interactions) and service recommendations (820). Based on this analysis (or as part of the analysis), the program code applies NPL techniques and/or one or more machine learning algorithms (trained as described in FIG. 3), to refine the recommendations (830). Based on the refinement, the program code provides optimized recommendations 896 (relevant to the user/customer) (840).

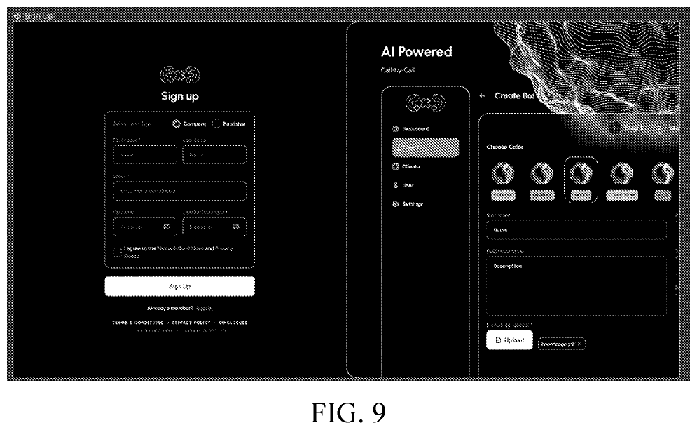

The examples herein enable a user from a given industry to customize its use of the examples herein to accommodate customer interactions within that industry including improving outcomes with existing systems. As illustrated in FIG. 9, an administrative user can configure the examples herein to interact with its existing CRM systems and general customer management processes on a call-by-call basis. In various examples herein, the program code can enhance customer data in various ways, including determining a personality type of a customer, enriching the data with additional data, and/or applying one or more machine learning algorithms (which can be trained on historical data), to provide a recommendation. However, when configuring a system, as administrative user may seek to select which analyses the program code should implement within its customer service operations. To this end, the administrative user can select various “bots” (AI processes) that the program code will implement, including on a call-by-call basis. FIG. 9 illustrates a graphical user interface (GUI) generated by the program code which the user can utilize to configure the example herein to integrate the aspects described herein into its operations.

The present invention provides a system and method for automating and enhancing customer interaction management across various industries through technological innovation and expert collaboration. This description outlines the major components of the invention, including the real-time audio recording and transcription module, the dynamic CRM data integration module, the expert coaching marketplace, and the provisions for future scalability through third-party data integrations.

The examples herein include systems, computer program products, and computer-implemented methods that can be utilized to facilitate and direct customer service systems, which can include facilitating efficient and effective customer interactions across various industries, which can be applicable to both in-person and phone-based interactions. In these examples, program code executing on one or more processors records audio from customer interactions in real-time, transcribes the recorded audio into text, integrates the transcribed text with dynamic data from Customer Relationship Management (CRM) systems, analyzes the integrated data to determine a customer's personality type based on a predefined personality assessment framework and to assess initial phone call sentiment, accesses one or more AI-driven coaching bots that analyze the integrated data (which can also be understood as machine-learning algorithms or models), including personality type indicators and phone call sentiment, and deliver real-time feedback, including to employees based on the comprehensive analysis, tailored to one or more of the personality type, historical context, initial sentiment, and/or other relevant data of the customer. The feedback provided by the program code can be based on the program code additionally accessing and analyzing third-party data, which may include real estate databases and/or demographic databases. The program code can also adapt feedback strategies based on the comprehensive analysis of combined data sources, enhancing the personalized approach to each customer interaction. In some examples, the program code can leverage a personality classification (by the program code) and a recommendation (by the program code) and generate a sale strategy.

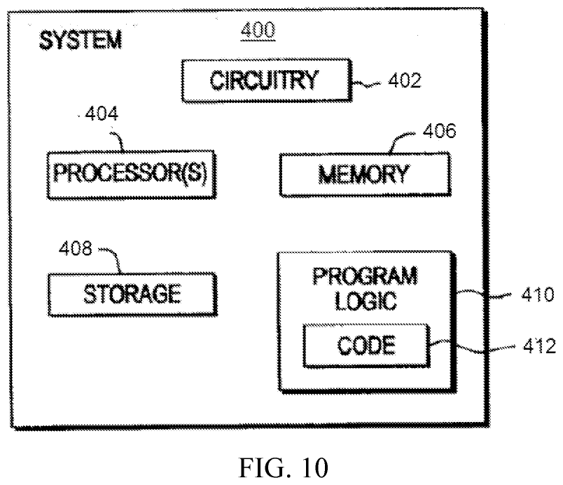

FIG. 10 illustrates a block diagram of a resource 400 in computer system, such as, which is part of the technical architecture of certain embodiments of the technique. Returning to FIG. 10, the resource 400 may include a circuitry 502 that may in certain embodiments include a microprocessor 504. The computer system 400 may also include a memory 506 (e.g., a volatile memory device), and storage 508. The storage 508 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 508 may comprise an internal storage device, an attached storage device and/or a network accessible storage device. The system 400 may include a program logic 510 including code 512 that may be loaded into the memory 506 and executed by the microprocessor 504 or circuitry 502.

In certain embodiments, the program logic 510 including code 512 may be stored in the storage 508, or memory 506. In certain other embodiments, the program logic 510 may be implemented in the circuitry 502. Therefore, while FIG. 10 shows the program logic 510 separately from the other elements, the program logic 510 may be implemented in the memory 506 and/or the circuitry 502. The program logic 510 may include the program code discussed in this disclosure that facilitates the reconfiguration of elements of various computer networks, including those in various figures.

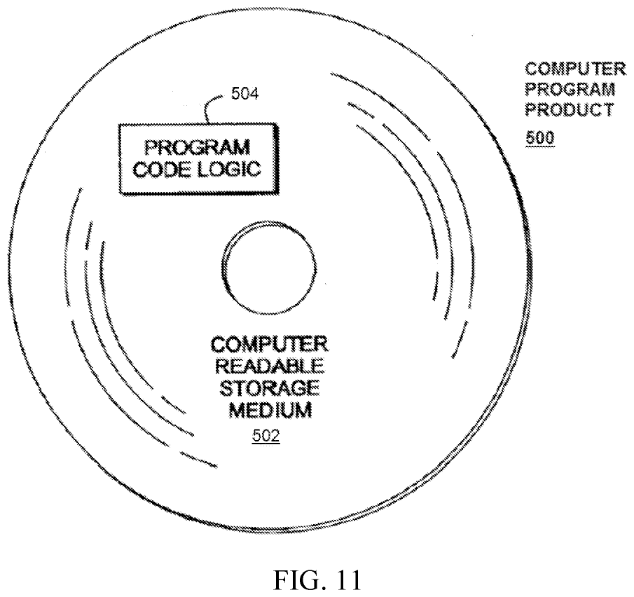

Using the processing resources of a resource 400 to execute software, computer-readable code or instructions, does not limit where this code can be stored. Referring to FIG. 11, in one example, a computer program product 500 includes, for instance, one or more non-transitory computer readable storage media 602 to store computer readable program code means or logic 604 thereon to provide and facilitate one or more aspects of the technique.

As will be appreciated by one skilled in the art, aspects of the technique may be embodied as a system, method or computer program product. Accordingly, aspects of the technique may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the technique may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus or device.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the technique may be written in any combination of one or more programming languages, including an object oriented programming language, such as Java, Smalltalk, C++ or the like, and conventional procedural programming languages, such as the “C” programming language, PHP, ASP, assembler or similar programming languages, as well as functional programming languages and languages for technical computing (e.g., Matlab). The program code may execute entirely on the user's computer, partly on the user's computer, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Furthermore, more than one computer can be used for implementing the program code, including, but not limited to, one or more resources in a cloud computing environment.

Aspects of the technique are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions, also referred to as software and/or program code, may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the technique. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition to the above, one or more aspects of the technique may be provided, offered, deployed, managed, serviced, etc. by a service provider who offers management of customer environments. For instance, the service provider can create, maintain, support, etc. computer code and/or a computer infrastructure that performs one or more aspects of the technique for one or more customers. In return, the service provider may receive payment from the customer under a subscription and/or fee agreement, as examples. Additionally or alternatively, the service provider may receive payment from the sale of advertising content to one or more third parties.

In one aspect of the technique, an application may be deployed for performing one or more aspects of the technique. As one example, the deploying of an application comprises providing computer infrastructure operable to perform one or more aspects of the technique.

As a further aspect of the technique, a computing infrastructure may be deployed comprising integrating computer readable code into a computing system, in which the code in combination with the computing system is capable of performing one or more aspects of the technique.

As yet a further aspect of the technique, a process for integrating computing infrastructure comprising integrating computer readable code into a computer system may be provided. The computer system comprises a computer readable medium, in which the computer medium comprises one or more aspects of the technique. The code in combination with the computer system is capable of performing one or more aspects of the technique.

Further, other types of computing environments can benefit from one or more aspects of the technique. As an example, an environment may include an emulator (e.g., software or other emulation mechanisms), in which a particular architecture (including, for instance, instruction execution, architected functions, such as address translation, and architected registers) or a subset thereof is emulated (e.g., on a native computer system having a processor and memory). In such an environment, one or more emulation functions of the emulator can implement one or more aspects of the technique, even though a computer executing the emulator may have a different architecture than the capabilities being emulated. As one example, in emulation mode, the specific instruction or operation being emulated is decoded, and an appropriate emulation function is built to implement the individual instruction or operation.

In an emulation environment, a host computer includes, for instance, a memory to store instructions and data; an instruction fetch unit to fetch instructions from memory and to optionally, provide local buffering for the fetched instruction; an instruction decode unit to receive the fetched instructions and to determine the type of instructions that have been fetched; and an instruction execution unit to execute the instructions. Execution may include loading data into a register from memory; storing data back to memory from a register; or performing some type of arithmetic or logical operation, as determined by the decode unit. In one example, each unit is implemented in software. For instance, the operations being performed by the units are implemented as one or more subroutines within emulator software.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or steps plus function elements in the descriptions below, if any, are intended to include any structure, material, or act for performing the function in combination with other elements as specifically noted. The description of the technique has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described to best explain the principles of the invention and the practical application, and to enable others of ordinary skill in the art to understand the invention for various embodiments with various modifications as are suited to the particular uses contemplated.

1. A computer-implemented method comprising:
training, by one or more processors, one or more machine learning algorithms to recommend an action based on receiving an audio communication via a consumer interface;
obtaining, by the one or more processors, the audio communication via the consumer interface, wherein the one or more processors access the customer relationship management system via a first application programming interface;
progressively converting, by the one or more processors, the audio communication to textual content in real-time or in near real-time;
classifying, by the one or more processors, an originator of the audio communication as a given personality type from a pre-determined group of personality types based on analyzing the textual content, wherein the given personality type and the textual content comprise customer information;
expanding, by the one or more processors, the customer information based on accessing a customer relationship management system via a second application programming interface and at least one additional data source to obtain data relevant to the originator of the audio communication;
selecting, by the one or more processors, at least one machine learning algorithm from the one or more machine learning algorithms and applying the at least one machine learning algorithm to the expanded customer information;
based on the applying, obtaining, by the one or more processors, the action; and
implementing, by the one or more processors, the action.

2. The computer-implemented method of claim 1, wherein the training comprises:
identifying, by the one or more processors, one or more sets of training data, where the training data comprises historical actions of customers in a database accessible to the customer relationship management system and demographic information related to the customer in the database;
performing, by the one or more processors, a cognitive analysis of the one or more sets of training data to identify patterns comprising relationships between customers with given attributes and given actions; and
training, by the one or more processors, the one or more machine learning algorithms to recognize the patterns.

3. The computer-implemented method of claim 1, further comprising:
generating, by the one or more processors, a graphical user interface to display the one or more machine learning algorithms for selection by a user; and
obtaining, by the one or more processors, via the graphical user interface, a designation of the at least one machine learning algorithm, wherein the selecting the at least one machine learning algorithm is based on the obtaining.

4. The computer-implemented method of claim 1, wherein the one or more machine learning algorithms comprise artificially intelligent bots.

5. The computer-implemented method of claim 1, wherein implementing the action comprises:
transmitting, by the one or more processors, via the second application programming interface, the action to the consumer interface, wherein the action comprises a recommendation for an individual interacting with the originator.

6. The computer-implemented method of claim 1, wherein the at least one additional data is selected from the group comprising: a real estate database, census data, and public records.

7. The computer-implemented method of claim 1, wherein the pre-determined group of personality types comprise Myers-Briggs personality types or DISC profiles.

8. The computer-implemented method of claim 1, further comprising:
monitoring, by the one or more processors, the implementing of the action; and
refining, by the one or more processors, the at least one machine learning algorithm, based on the monitoring.

9. The computer-implemented method of claim 2, wherein the training further comprises:
generating, by the one or more processors, a graphical user interface to display the patterns comprising the relationships between customers with given attributes and given actions;
displaying, by the one or more processors, the patterns for editing by a subject matter expert;
obtaining, by the one or more processors, via the graphical user interface one or more edits; and
adjusting, by the one or more processors, the one or more machine learning algorithms based on the one or more edits.

10. A computer program product comprising:
a storage medium readable by a processing circuit and storing instructions for execution by the processing circuit for performing a method, the method comprising:
training, by one or more processors, one or more machine learning algorithms to recommend an action based on receiving an audio communication via a consumer interface;
obtaining, by the one or more processors, the audio communication via the consumer interface, wherein the one or more processors access the customer relationship management system via a first application programming interface;
progressively converting, by the one or more processors, the audio communication to textual content in real-time or in near real-time;
classifying, by the one or more processors, an originator of the audio communication as a given personality type from a pre-determined group of personality types based on analyzing the textual content, wherein the given personality type and the textual content comprise customer information;
expanding, by the one or more processors, the customer information based on accessing a customer relationship management system via a second application programming interface and at least one additional data source to obtain data relevant to the originator of the audio communication;
selecting, by the one or more processors, at least one machine learning algorithm from the one or more machine learning algorithms and applying the at least one machine learning algorithm to the expanded customer information;
based on the applying, obtaining, by the one or more processors, the action; and
implementing, by the one or more processors, the action.

11. The computer program product of claim 10, wherein the training comprises:
identifying, by the one or more processors, one or more sets of training data, where the training data comprises historical actions of customers in a database accessible to the customer relationship management system and demographic information related to the customer in the database;
performing, by the one or more processors, a cognitive analysis of the one or more sets of training data to identify patterns comprising relationships between customers with given attributes and given actions; and
training, by the one or more processors, the one or more machine learning algorithms to recognize the patterns.

12. The computer program product of claim 10, the method further comprising:
generating, by the one or more processors, a graphical user interface to display the one or more machine learning algorithms for selection by a user; and
obtaining, by the one or more processors, via the graphical user interface, a designation of the at least one machine learning algorithm, wherein the selecting the at least one machine learning algorithm is based on the obtaining.

13. The computer program product of claim 10, wherein the one or more machine learning algorithms comprise artificially intelligent bots.

14. The computer program product of claim 10, wherein implementing the action comprises:
transmitting, by the one or more processors, via the second application programming interface, the action to the consumer interface, wherein the action comprises a recommendation for an individual interacting with the originator.

15. The computer program product of claim 10, wherein the at least one additional data is selected from the group comprising: a real estate database, census data, and public records.

16. The computer program product of claim 10, wherein the pre-determined group of personality types comprise Myers-Briggs personality types or DISC profiles.

17. A system comprising:
a memory; and
one or more processors in communication with the memory and with the a plurality of sensors, wherein the computer system is configured to perform a method, said method comprising:
training, by the one or more processors, one or more machine learning algorithms to recommend an action based on receiving an audio communication via a consumer interface;
obtaining, by the one or more processors, the audio communication via the consumer interface, wherein the one or more processors access the customer relationship management system via a first application programming interface;
progressively converting, by the one or more processors, the audio communication to textual content in real-time or in near real-time;
classifying, by the one or more processors, an originator of the audio communication as a given personality type from a pre-determined group of personality types based on analyzing the textual content, wherein the given personality type and the textual content comprise customer information;
expanding, by the one or more processors, the customer information based on accessing a customer relationship management system via a second application programming interface and at least one additional data source to obtain data relevant to the originator of the audio communication;
selecting, by the one or more processors, at least one machine learning algorithm from the one or more machine learning algorithms and applying the at least one machine learning algorithm to the expanded customer information;
based on the applying, obtaining, by the one or more processors, the action; and
implementing, by the one or more processors, the action.

18. The system of claim 17, wherein the training comprises:
identifying, by the one or more processors, one or more sets of training data, where the training data comprises historical actions of customers in a database accessible to the customer relationship management system and demographic information related to the customer in the database;
performing, by the one or more processors, a cognitive analysis of the one or more sets of training data to identify patterns comprising relationships between customers with given attributes and given actions; and
training, by the one or more processors, the one or more machine learning algorithms to recognize the patterns.

19. The system of claim 17, the method further comprising:
generating, by the one or more processors, a graphical user interface to display the one or more machine learning algorithms for selection by a user; and
obtaining, by the one or more processors, via the graphical user interface, a designation of the at least one machine learning algorithm, wherein the selecting the at least one machine learning algorithm is based on the obtaining.

20. The system of claim 17, wherein the one or more machine learning algorithms comprise artificially intelligent bots.
